(19) United States
(12) Patent Application Publication
(10) Pub. No.: US 2013/0218918 A1
(43) Pub. Date: Aug. 22, 2013

(54) CLAIM BASED EXECUTION CONTROL

(71) Applicants: Gopinathan Kannan, Redmond, WA (US); Mitica Manu, Sammamish, WA (US)

(72) Inventors: Gopinathan Kannan, Redmond, WA (US); Mitica Manu, Sammamish, WA (US)

(73) Assignee: MICROSOFT CORPORATION, Redmond, WA (US)

(21) Appl. No.: 13/398,463

(22) Filed: Feb. 16, 2012

(51) Int. Cl. G06F 17/30

(52) U.S. Cl. 707/758; 707/E17.01; 707/E17.005

(57) ABSTRACT

Methods, systems, and computer program products are provided for using a claims model to control the execution of an execution unit. The execution unit is executed. An identity principal is identified under which the execution unit is executed. At least one claim is identified that is required for the execution unit. Each identified claim has a claim name and a claim value. One or more claims associated with the identified identity principal is/are requested from a claims provider. The claim(s) is/are received from the claims provider. The received claim(s) is/are compared with the identified claim(s). An action for the identified claim(s) is determined based on a result of the comparison.

### BACKGROUND

Executable files include instructions encoded in machine code that define programs. An executable file may be executed to cause a computer to perform tasks defined by the encoded instructions. Executable files can have various file formats, including being binary files (e.g., “binaries”), and may have various file extensions, such as “.exe”.

Currently, execution control for programs may be realized only at the executable file level based on identity or access control information of a principal. This principal may be the user who is executing the program file binary or a machine on which the binary is being executed. Any finer level of execution control beyond that is not currently available. As such, IT (information technology) professionals and security administrators are not able to change the behavior of a program during runtime at more granular levels based on such information (identity or access control).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for controlling the execution of an execution unit according to a claims model. The execution unit may be an executable file, or a portion of an executable file, such as a class or a method. An identity of an identity principal under which the execution unit is executed is determined and passed to a claims provider. The claims provider queries a map, a policy engine, or other object or component to generate claims for the identity principal. The generated claims indicate attributes of the identified identity principal. The execution unit uses these claims to potentially change the behavior of the execution unit, thereby controlling execution unit behavior. Because an execution unit may be a portion of an executable file, the behavior of a program may be changed during execution at levels that are more granular than the executable file itself.

In one method implementation, an execution unit is executed. An identity principal is identified under which the execution unit is executed. At least one claim is identified that is required for the execution unit. Each identified claim has a claim name and a claim value. Claims associated with the identified identity principal are requested from a claims provider, and are received from the claims provider. The received claims are compared with the identified claim(s). An action for the identified claim(s) is determined based on a result of the comparison, and may be performed.

In one system implementation, an execution unit includes a user identification module, a claims identifier module, a user claims determiner, a claims comparator, and an action determiner. The user identification module identifies an identity principal under which the execution unit is executed. The claims identifier module identifies at least one claim that is required for the execution unit. The user claims determiner requests one or more claims associated with the identified identity principal from a claims provider, and receives the one or more claims from the claims provider. The claims comparator compares the received one or more claims with the identified claim(s). The action determiner determines one or more actions for the identified claim(s) based on a result of the comparison.

Computer program products containing computer readable storage media are also described herein that store computer code/instructions for controlling execution of an execution unit according to a claims model, as well as for additional embodiments described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a computing system that uses a claims model to control the execution of an execution unit, according to an example embodiment.

FIG. 2 shows a flowchart providing a process for controlling the execution of execution units using a claims model, according to an example embodiment.

FIG. 3 shows a block diagram of an execution unit that implements a claims model to control execution, according to an example embodiment.

FIG. 4 shows a block diagram of a computing device that uses a claims model to control the execution of an execution unit and includes a policy engine for generating user claims, according to an example embodiment.

FIG. 5 shows a block diagram of an action performer configured to perform actions determined for claims, according to an example embodiment.

FIG. 6 shows a flowchart providing a process for performing various examples of actions, according to an example embodiment.

FIG. 7 shows a block diagram of a computing device that uses a claims model to control the execution of an execution unit and logs an event in an event log as an action, according to an example embodiment.

FIG. 8 shows a block diagram of a computing device that uses a claims model to control the execution of an execution unit and accesses a claims cache for cached claims, according to an example embodiment.

FIG. 9 shows a process for caching claims, according to an example embodiment.

FIG. 10 shows a flowchart providing a process for accessing a claims cache for claims, according to an example embodiment.

FIG. 11 shows a block diagram of an example computer that may be used to implement embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments of the present invention are described as follows. It noted that any section/subsection headings provided herein are not intended to be limiting. Embodiments are described throughout this document, and any type of embodiment may be included under any section/subsection.

### II. Example Embodiments

An executable file for a program may be executed to cause a computer to perform tasks defined by the instructions encoded within. Executable files can have various file formats, including being binary files (e.g., “binaries”), and may have various file extensions, such as “.exe”. Currently execution control for executable files is realized at the executable file level. A finer level of execution control based on user's identity and/or access control information is not available. As such, IT (information technology) professionals and security administrators are not able to change the behavior of a program during execution at more granular levels than at the level of the program itself, unless specific code is added to change the execution flow based on specific identity principals, groups of identity principals, or static properties of identity principals.

Embodiments enable execution control for executable files to realized at different levels, including at the executable file level (least granular level), at the class level, and at the method level (most granular level). Embodiments use a claims model to control the execution of these programming elements (e.g., executable files, classes, methods, etc.), where claims are used to indicate attributes of an identity principal. As such, IT professionals and security administrators are enabled to change program behavior during execution at more granular levels than just at the level of the program itself.

According an embodiment, an identity of an identity principal, such as a user (e.g., a user account), a service (e.g., a service account), a computer (e.g., a computer account), or a compounded identity (e.g., includes a user and a computer, etc.), under which an .execution unit (e.g., an executable file, a class, or a method) is executed is determined and passed to a claims provider (also known as a “claims engine”). The claims provider queries a map, a policy engine, or other object or component to generate claims for the identity principal based on factors such as the identity principal attributes and execution context. The generated claims—statements of fact, such as what the identity principal is or is not—indicate attributes of the identified identity principal. The execution unit (also referred to as an “execution engine”) uses these claims to potentially change the behavior of the execution unit, thereby controlling execution unit behavior.

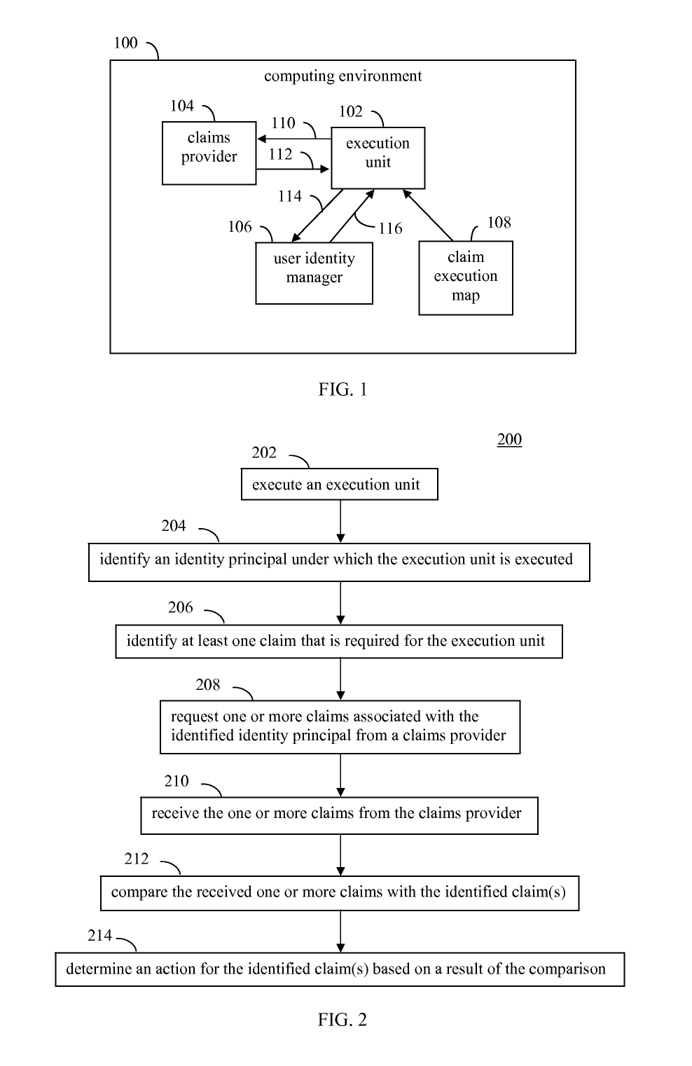

For instance, FIG. 1 shows a block diagram of a computing environment 100 that uses a claims model to control the execution of an execution unit, according to an example embodiment. Computing environment 100 is a computer system that may be implemented by any number of one or more computing devices. As shown in FIG. 1, computing environment 100 includes an execution unit 102, a claims provider 104, a user identity manager 106, and a claim execution map 108. Computing environment 100 is described as follows.

Computing environment 100 may be any type of stationary or mobile computing device, including a desktop computer (e.g., a personal computer, etc.), a mobile computer or computing device (e.g., a Palm® device, a RIM Blackberry® device, a personal digital assistant (PDA), a laptop computer, a notebook computer, a tablet computer (e.g., an Apple iPad™), a netbook, etc.), a server, a smart phone (e.g., an Apple iPhone, a Google Android™ phone, a Microsoft Windows® phone, etc.), or other type of computing device.

Execution unit 102 is an executable file, or a portion of an executable file, such as a class or a method. A “class” is a construct (e.g., in object-oriented programming) that is used as a blueprint to create instances of itself, which may be referred to as class instances, class objects, instance objects, or objects. A class defines constituent members which enable these class instances to have state and behavior. Data field members (member variables or instance variables) enable a class object to maintain state. Other kinds of members, such as methods, enable a behavior of a class object. A “method” is a subroutine (or procedure or function) associated with a class. A method defines a behavior to be exhibited by instances of the associated class at program run time. At runtime, a method has access to data stored in an instance of the associated class, and thereby can control the state of the instance. A method associated with a class is “bound” to the class. A method can be bound to a class at compile time (static binding) or to an object at runtime (dynamic binding).

Execution unit 102 may be an executable file, or a portion of an executable, such as a class, a method, or other portion. Execution unit 102 may be in binary code form or other form. At runtime, execution unit 102 may encounter a required claim. For instance, machine code of execution unit 102 may be executed by one or more processors of computing environment 100. One or more claims (e.g., a collection of claims) may be encountered in the machine code. The claim(s) may indicate one or more attributes that are required to be held by an identity principal (e.g., a user account, a service account, a computer account, a compounded identity, etc.) under which execution unit 102 is being executed. For instance, the encountered claim may have a claim name and a claim value. For instance, a first claim may have a claim name of “UserType” and a claim value of “FTE,” and a second claim may have the claim name of “Department” and the claim value of “Department101.” To satisfy the claim, the identity principal has to have the claim value of the encountered claim as an attribute for the named claim. Depending on whether or not the claim is satisfied, execution unit 102 may perform one or more actions.

Execution unit 102 may communicate with user identity manager 106 to identify the identity principal under which execution unit 102 is being executed. For instance, as shown in FIG. 1, execution unit 102 may provide/transmit a user identity request 114 to user identity manager 106. User identity manager 106 may provide/transmit a user identity response 116 to execution unit 102 that includes an indication of the identity of the identity principal. User identity manager 106 may be implemented in any manner to track and identify identity principals. For example, in an embodiment, user identity manager 106 may be implemented in Active Directory® provided by Microsoft Corporation of Redmond, Wash., or in another commercially available service or proprietary service for authenticating and authorizing identity principals in a computer domain, forest, or multiple forests. A forest is a collection of trees, which each include one or more domains, and represents a security boundary within which users, computers, groups, and other objects are accessible. User identity manager 106 may track an identity principal that is operating a current session on computing environment 100 in which execution unit 102 executes, and may indicate the identity principal to execution unit 102 in user identity response 116 in the form of an account identifier (e.g., numerical or alphanumerical) for a user account, service account, computer account, a compounded identity, etc., or in other form.

Execution unit 102 may communicate with claims provider 104 to determine the relevant claim attributes that are held by the identified identity principal. For instance, as shown in FIG. 1, execution unit 102 may provide/transmit a user claims request 110 to claims provider 104. Claim provider 104 tracks or has access to the claims associated with one or more identity principals (e.g., identity principals of computing environment 100). Claims provider 104 may transmit a user claims indication 112 to execution unit 102 that includes an indication of the relevant claim attributes of the identity principal. Claims provider 104 may be implemented in any manner to track identity principal claims. Identity principal claims may change from time to time, based on changes in attributes of the identity principal (e.g., changes in employee status, etc.), and updated claims attributes may be maintained by claims provider 104. In an embodiment, claims provider 104 may be implemented in Active Directory®, or in another commercially available service or proprietary service for tracking identity principal claims in a computer domain. Claims provider 104 may indicate the identity principal claims to execution unit 102 in user claims indication 112 in any form (e.g., as one or more tuples that each include a corresponding claim name and claim value for the identity principal, etc.).

Execution unit 102 may determine whether the claim attributes held by the identified identity principal satisfy the encountered claim, such as by comparing the claim value(s) received for the identity principal with the corresponding claim value(s) indicated in the encountered claim. As shown in FIG. 1, execution unit 102 may access claim execution map 108, which indicates the action(s) to be performed if a claim is or is not satisfied. Execution unit 102 may look up the encountered claim in claim execution map 108 for the corresponding action(s). Execution unit 102 may then perform the resultant action(s).

In embodiments, execution unit 102, claims provider 104, and user identity manager 106 may be implemented in hardware, software, firmware, or any combination thereof. For example, execution unit 102, claims provider 104, and/or user identity manager 106 may be implemented as computer program code configured to be executed in one or more processors, may be implemented as hardware logic/electrical circuitry, and/or may be implemented in another manner. Claim execution map 108 may be maintained/updated by a same entity that includes claims provider 104 (e.g., Active Directory®) or by another entity. In an embodiment, claim execution map 108 may have the form of any suitable data structure (e.g., a file, a table, an array, etc.) and may be stored in storage of computing environment 100. The storage of computing environment 100 may include one or more of any type of storage mechanism to store data and/or code, including a magnetic disk (e.g., in a hard disk drive), an optical disc (e.g., in an optical disk drive), a magnetic tape (e.g., in a tape drive), a memory device such as a RAM device, etc., and/or any other suitable type of storage medium.

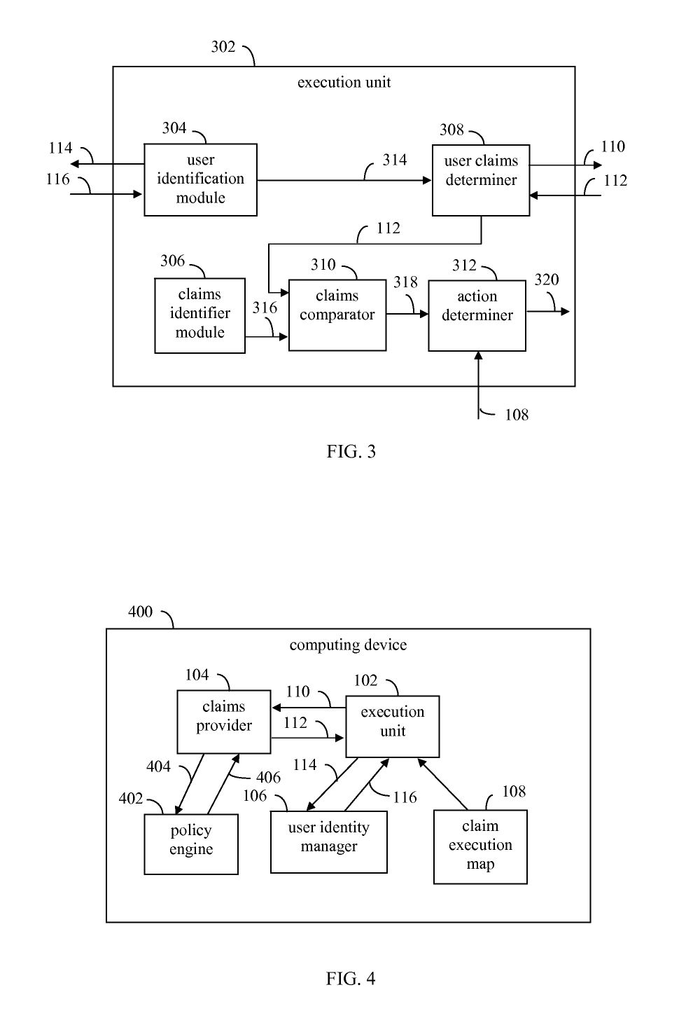

Execution unit 102 may perform its functions in various ways, in embodiments. For instance, FIG. 2 shows a flowchart 200 providing a process for controlling the execution of execution units using a claims model, according to an example embodiment. In an embodiment, flowchart 200 may be performed by execution unit 102 of FIG. 1. Flowchart 200 is described as follows with reference to FIG. 3. FIG. 3 shows a block diagram of an execution unit 302 that implements a claims model to control execution, according to an example embodiment. Execution unit 302 is an example embodiment of execution unit 102 of FIG. 1. As shown in FIG. 3, execution unit 302 includes a user identification module 304, a claims identifier module 306, a user claims determiner 308, a claims comparator 310, and an action determiner 312. Further structural and operational embodiments will be apparent to persons skilled in the relevant art(s) based on the following discussion regarding flowchart 200 and execution unit 302.

Flowchart 200 begins with step 202. In step 202, an execution unit is executed. For example, execution unit 302 may include machine code that may be executed by one or more processors of a computing device (e.g., computing environment 100 of FIG. 1). Execution unit 302 may be an executable file, or a portion of an executable, such as a class, a method, or other portion. Execution unit 302 may be in binary code form or other form.

In step 204, an identity principal under which the execution unit is executed is identified. For instance, in an embodiment, user identification module 304 may identify an identity principal under which execution unit 302 is executed. With regard to FIG. 1, user identification module 304 may communicate with user identity manager 106 to identify the identity principal under which execution unit 302 is being executed, such as by user account (e.g., login identifier, etc.), etc. As shown in FIG. 3, user identification module 304 may transmit user identity request 114 to user identity manager 106 of FIG. 1. User identity manager 106 may transmit user identity response 116 that is received by user identification module 304. User identity response 116 includes an indication of the identity of the identity principal, which is output by user identification module 304 as identified user 314.

Note that user identification module 304 may identify the identity principal under which execution unit 302 is executed at any time, including before execution unit 302 is executed, when execution unit 302 is started, or after execution unit 302 is executing. Furthermore, user identification module 304 may identify the identity principal a single time, or may repeatedly identify the identity principal, such as at regular (periodic) intervals or irregular (non-periodic) intervals.

Referring back to FIG. 2, in step 206, at least one claim that is required for the execution unit is identified. For instance, in an embodiment, claims identifier module 306 may identify one or more claims that is/are required for execution unit 302. A required claim is a claim that has to be evaluated to determine how to proceed forward from a current point in the executing code (e.g., what action is to be performed). For instance, depending on how a required claim is evaluated, particular code of execution unit 302 may be executed and/or not executed. The claim may be present in the machine code of execution unit 302, and may be detected by claims identifier module 306 when encountered in the machine code by one or more processors executing the machine code. Claims identifier module 306 may identify the claim(s) by the attributes associated with it/them, such as a claim name and a claim value. Based on the claim value held by the identified identity principal for the identified claim(s), various actions may be undertaken. As shown in FIG. 3, claims identifier module 306 outputs an identified claim 316, which includes one or more identified claims, and at least includes the claim attributes of claim name (or type) and claim value for each identified claim.

For instance, in one example, a claim may have the following attributes:

Claim Name=EmployeeType

Claim Value=FullTimeEmployee

Such a claim may be encountered when executing execution unit 302. In this example, an identity principal under which execution unit 302 executes may be a particular type of employee of an entity. According to the claim, whether the identity principal is an employee of type full time employee (FTE) is to be ascertained, and based on this determination various actions may accordingly be taken.

Referring back to FIG. 2, in step 208, one or more claims associated with the identified identity principal is/are requested from a claims provider. For instance, as shown in FIG. 3, user claims determiner 308 receives identified identity principal 314, which indicates the identity of the identity principal. User claims determiner 308 may communicate with claims provider 104 (FIG. 1) to determine the relevant claims that are held by the identified identity principal. For instance, as shown in FIG. 3, user claims determiner 308 may transmit user claims request 110 to claims provider 104. User claims request 110 indicates the identity principal indicated in identified user 314, and requests any claim attributes that are specifically associated with that identity principal.

As described above, claims provider 104 generates the claims specific to a provided user identity in identified identity principal 314. Claims provider 104 may be configured in various ways, in embodiments. For instance, in one embodiment, claims provider 104 may maintain a user claims map. The user claims map may be a fixed map that indicates a list of one or more claims (e.g., claim name/claim value pairs) for each listed identity principal. In another embodiment, claims provider 104 may access a policy engine for the identity principal claims.

For instance, FIG. 4 shows a block diagram of a computing device 400 that includes a policy engine for the generating of identity principal claims, according to an example embodiment. Computing device 400 is generally similar to computing environment 100 of FIG. 1, containing execution unit 102, claims provider 104, user identity manager 106, and claim execution map 108. Furthermore, computing device 400 includes a policy engine 402. Policy engine 402 is used for dynamic generation of claims for identity principals based on pre-defined policies/rules. As shown in FIG. 4, claims provider 104 may provide a user claims request 404 to policy engine 402 based on user claims request 110. User claims request 404 may indicate the identity principal identity, and may optionally indicate the claim name of the encountered claim, as well as other relevant information, such as the client location, client IP address, etc. Policy engine 402 may process the information included in user claims request 404 based on the relevant policies for the identified identity principal and/or named claim, to generate the applicable claims (e.g., the claim name(s) and claim value(s) for the identity principal). As shown in FIG. 4, policy engine 402 may provide the generated claims for the identity principal to claims provider 104 in generated claims 406.

Referring back to FIG. 2, in step 210, the one or more claims is/are received from the claims provider. For example, as shown in FIG. 3, claims provider 104 (of FIG. 1) may transmit user claims indication 112 to user claims determiner 308 to provide an indication of the claims that are associated with the identified identity principal.

For instance, continuing the above example, the identity principal identified in step 204 may have the following associated claims/claim attributes maintained/provided by claims provider 104 (e.g., in the form of attribute name/value pairs):

Claim Name=EmployeeType Claim Value=Contractor

Claim Name=ResidenceCityClaim Value=Sunnyvale

Claim Name=JobTitle Claim Value=Manager

. . .

In this example, the identity principal is a user that has at least three associated claims, having claim names of “EmployeeType,” “ResidenceCity,” and “JobTitle,” and a corresponding claim value for each of the claim names. One or more of these claims may be provided by claims provider 104 in user claims indication 112. It is noted that in embodiments, an identity principal may have any number of associated claims that are maintained by claims provider 104.

Furthermore, it is noted that in an embodiment, claims provider 104 may transmit all of the identified identity principal's associated claims to user claims determiner 308 in user claims indication 112. In another embodiment, user claims determiner 308 may receive identified claim 316 from claims identifier module 306, and may request in user claims request 110 that claims provider 104 provide just the claim information for identified claim 316 for the identity principal in user claims indication 112 (rather than providing all of the claims associated with the identified identity principal in user claims indication 112).

Referring back to FIG. 2, in step 212, the received one or more claims are compared with the identified claim(s). For instance, as shown in FIG. 3, claims comparator 310 receives identified claim 316 and user claims indication 112. In an embodiment, claims comparator 310 compares each identified claim of identified claim 316 to the one or more claims in user claims indication 112 to determine whether a match exists. For instance, claims comparator 310 may compare the claim value for each named claim in identified claim 316 with the claim value for the same named claim in user claims indication 112 to determine whether they are the same claim value, and generates a compare result 318. If all of the claim values match (are the same), claims comparator 310 may generate compare result 318 to include a matching indication (e.g., a “true” value, a “1” value, a textual value of “match,” etc.). If one or more of the claim values do not match (are not the same), claims comparator 310 may generate compare result 318 to include a non-matching indication (e.g., a “false” value, a “0” value, a textual value of “not matching,” etc.).

For instance, continuing the above example, identified claim 316 may have included the encountered claim having the claim name of EmployeeType and the claim value of “FullTimeEmployee”. As shown above for the identified identity principal, user claims indication 112 may include the claim value of “Contractor” for the claim name of EmployeeType. Claims comparator 310 may compare the two claim values, and because the claim values of FullTimeEmployee and Contractor do not match, may generate compare result 318 to include a non-matching indication in this example.

Referring back to FIG. 2, in step 214, an action for the identified claim(s) is determined based on a result of the comparison. For instance, as shown in FIG. 3, action determiner 312 receives compare result 318. Action determiner 312 is configured to determine one or more actions to be performed based on whether or not compare result 318 indicates a match.

For instance, in an embodiment, action determiner 312 may receive claim execution map 108. Claim execution map 108 may indicate one or more actions to be performed if a particular claim is or is not satisfied (a match does or does not occur). Execution unit 102 may look up the encountered claim in claim execution map 108 for the corresponding action(s).

For instance, in an embodiment, claim execution map 108 may include multiple entries that each include the following information (e.g., in the form of tuples):

Execution Unit Name

Requested Claim Name

Requested Claim Expected Value

First Action

Default Action

“Execution Unit Name” is a name of an execution unit corresponding to the entry. “Requested Claim Name” is a name of a claim corresponding to the entry. “Requested Claim Expected Value” is optionally present, and is the expected value for the claim corresponding to the entry for a match to occur. “First Action” (or “matching action”) is an action to be performed if the claim corresponding to the entry is satisfied (additional actions to be performed if the claim corresponding to the entry is satisfied may optionally be present). “Default Action” is an action to be performed if the claim corresponding to the entry is not satisfied (additional actions to be performed if the claim corresponding to the entry is not satisfied may optionally be present).

As such, one or more actions may be performed in response to a single claim being satisfied or not satisfied. Alternatively, one or more actions may be performed if multiple claims are determined to be satisfied and/or non-satisfied in a predetermined combination.

In an embodiment where the execution map includes execution map entries similar to the entry shown above, action determiner 312 may locate in claim execution map 108 an entry including the execution unit name for execution unit 302, and the claim name matching the claim encountered in execution unit 302. Action determiner 312 may determine the first action (and optionally further non-default actions) from the located entry if the claim is indicated as matched in compare result 318, or may determine the default action (and optionally further default actions) from the located entry if the claim is indicated as not matched in compare result 318. Action determiner 312 may optionally output the determined action(s) as determined action 320.

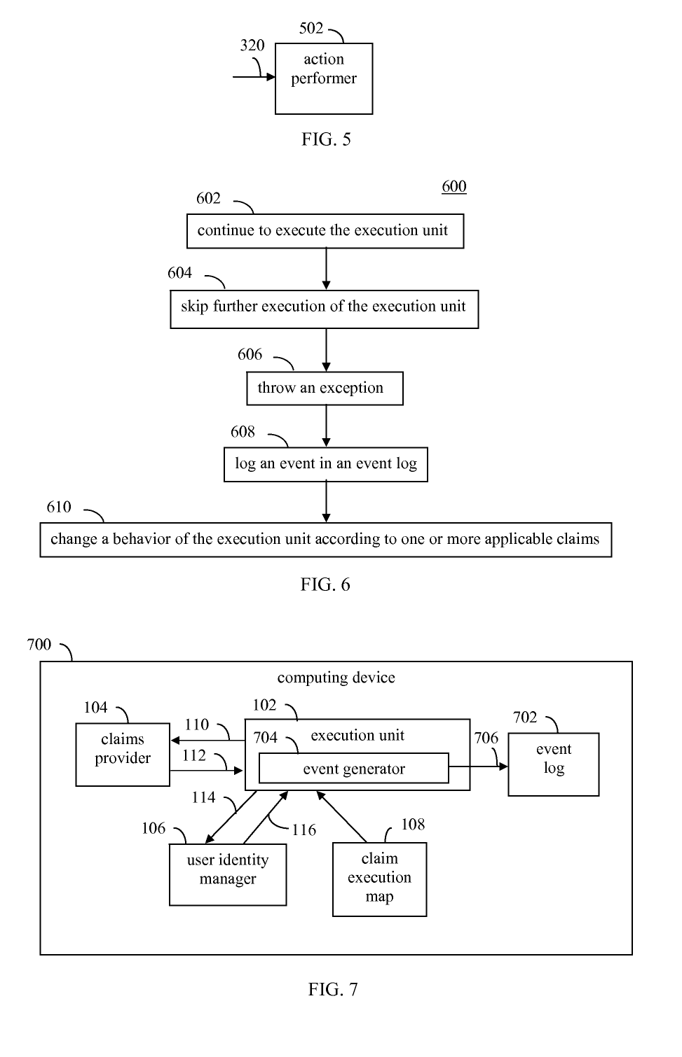

The action(s) included in determined action 320 may be performed in any manner. For instance, FIG. 5 shows a block diagram of an action performer 502 configured to perform actions determined for claims, according to an example embodiment. In embodiments, action performer 502 may be included in the execution unit or may be external to the execution unit. As shown in FIG. 5, action performer 502 receives determined action 320. Action performer 502 performs one or more actions indicated in determined action 320 and/or enables one or more actions indicated in determined action 320 to be performed.

Any number and type of actions may be performed by action performer 502. Such actions may or may not result in observable differences to the identity principal, and/or may result in unobservable differences for the identity principal. For instance, FIG. 6 shows a flowchart 600 providing a process for various examples of actions, according to an example embodiment. In an embodiment, flowchart 600 may be performed by action performer 502 of FIG. 5. Further structural and operational embodiments will be apparent to persons skilled in the relevant art(s) based on the following discussion regarding flowchart 600. Depending on the particular action(s) indicated by determined action 320, any one or more of the steps of flowchart 600 may be performed, and/or one or more alternative actions may be performed. Each of the actions of flowchart 600 may be performed as default or non-default actions.

Flowchart 600 begins with step 602. In step 602, execution of the execution unit is continued. Referring to FIG. 3, in an embodiment, an action indicated in determined action 320 may be for execution unit 302 to continue execution. For instance, action performer 502 may enable execution of the machine code of execution unit 302 to leave a subroutine or other code in which the claim was encountered, to proceed with the executing of other functionality of execution unit 302. In one embodiment, a trace of activity is not generated. In another embodiment, a trace of activity may be generated that records information about the execution of execution unit 302 (e.g., which may be used for debugging purposes, etc.).

In step 604, further execution of the execution unit is skipped. In an embodiment, an action indicated in determined action 320 may be for execution unit 302 to halt or discontinue execution. For instance, action performer 502 may cause execution of the machine code of execution unit 302 to halt from where the claim was encountered. In one embodiment, a trace of activity is not generated. In another embodiment, a trace of activity may be generated that records information about the halting of execution of execution unit 302 (e.g., which may be used for debugging purposes, etc.). Tracing may optionally be enabled for policy engine 402 (FIG. 4), when present.

In step 606, an exception is thrown. In an embodiment, an action indicated in determined action 320 may be for execution unit 302 to raise an exception. An exception is a type of condition that changes the normal flow of program execution. One mechanism for raising an exception is known as a throw. In such a case, the exception is said to be “thrown,” and execution is transferred to a “catch.” In an embodiment, action performer 502 may be a subroutine or other program code configured to raise or throw an exception. A developer of a program code may incorporate the ability raise an exception in the program code as a useful way to signal that a routine did not execute normally. In general, an exception is handled (resolved) by saving the current state of execution in a predefined place and switching the execution to a specific subroutine known as an exception handler. Depending on the situation, the exception handler may later resume the execution at the original location using the saved information. For example, a page fault will usually allow the program to be resumed, while a division by zero might not be resolvable transparently.

In step 608, an event is logged in an event log. In an embodiment, an action indicated in determined action 320 may be for an event log entry to be generated. In such an embodiment, action performer 502 may be configured to generate an event to be entered into an event log. For instance, FIG. 7 shows a block diagram of a computing device 700 that uses a claims model to control the execution of an execution unit and logs an event in an event log as an action, according to an example embodiment. Computing device 700 is generally similar to computing environment 100 of FIG. 1, containing execution unit 102, claims provider 104, user identity manager 106, and claim execution map 108. Furthermore, as shown in FIG. 7, execution unit 102 includes an event generator 704, which is an example of action performer 502 of FIG. 5. Event generator 704 generates an event 706 according to determined action 320, which is logged in an event log 702 maintained in computing device 700. Event 706 may indicate aspects of the operation of execution unit 302 related to the encountered claim, and may be used for various purposes, including providing an audit trail that can be used to understand the activity of execution unit 302 and/or to diagnose problems. Techniques for event generator 704 to generate an event will be known to persons skilled in the relevant art(s).

In step 610, a behavior of the execution unit is changed according to one or more applicable claims. Referring to FIG. 3, in an embodiment, an action indicated in determined action 320 may be for execution unit 302 to perform one or more functions (e.g., machine code routines) that change a behavior of execution unit 302 based on the one or more encountered claims. For instance, action performer 502 may enable execution of the machine code of execution unit 302 to perform one or more functions that change a behavior of execution unit 302 in any manner. In one example, for example, in a drop down list, one or more additional and/or fewer entries may be shown based on a claim being satisfied or not being satisfied.

Accordingly, various actions may be caused to be performed when a claim is satisfied or is not satisfied. Such actions include the actions described above and/or further actions. For instance, in one example, if the identity principal is determined to have satisfied/not satisfied one or more required claims, all of the functionality of execution unit 302 may proceed ahead, and no trace of the activity is generated. In another example, if the identity principal is determined to have satisfied one or more execution claims, but not one or more anonymity claims, there may be no visual difference in the execution of execution unit 302, but a trace of the identity principal may be generated. In another example, if an identity principal does not satisfy a particular claim that would allow him/her to use a specific feature of execution unit 302, the feature may be hidden from the identity principal or otherwise disabled with respect to the identity principal. In still another example, if an identity principal attempts to call a specific API (application programming interface) for which the identity principal does not satisfy a required execution claim, an exception may be thrown. Further examples of actions that may be performed, and situations in which particular actions may be performed, will be apparent to persons skilled in the relevant art(s) from the teachings herein.

As described above, in embodiments, an execution unit may communicate with claims provider 104 to determine the relevant claim attributes that are held by the identified identity principal. In an embodiment, an execution unit may cache the claim information received from claims provider 104 for an identity principal, for faster subsequent access and/or other reasons. The execution unit may access the cached claim information to process subsequent encountered claims for the identity principal, rather than re-requesting the claim information from claims provider 104 (which may be operating in a different program thread from a program thread in which the execution unit executes).

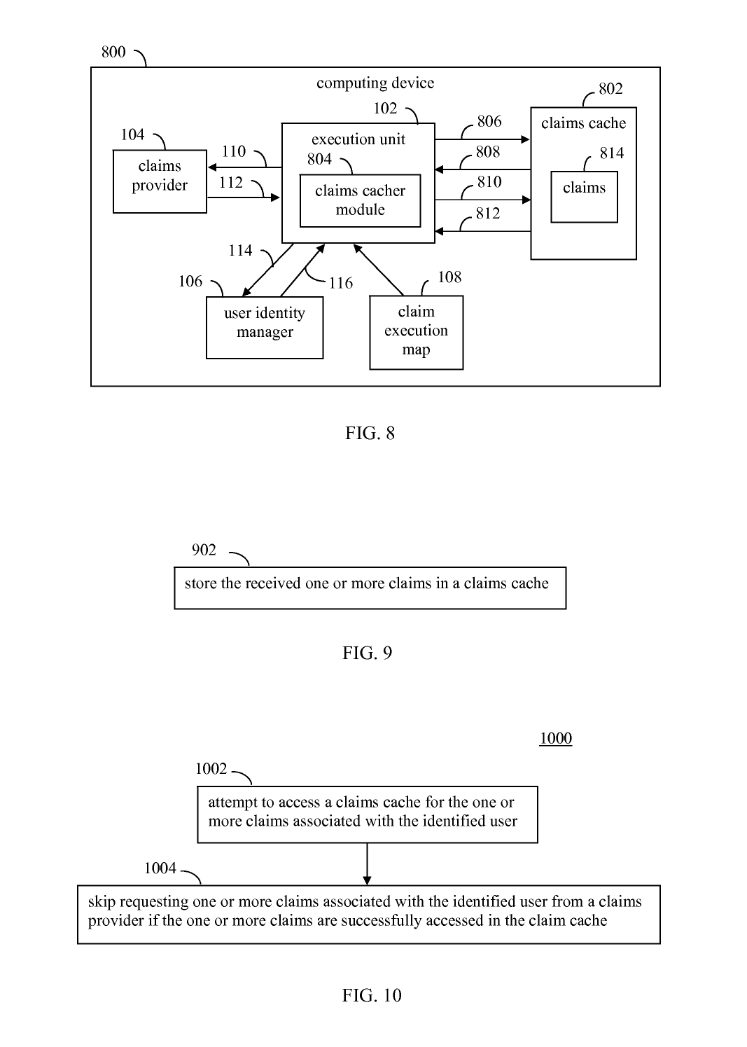

For instance, FIG. 8 shows a block diagram of a computing device 800 that accesses a claims cache for cached claims, according to an example embodiment. Computing device 800 is generally similar to computing environment 100 of FIG. 1, containing execution unit 102, claims provider 104, user identity manager 106, and claim execution map 108. Furthermore, computing device 800 includes a claims cache 802, and execution unit 102 includes a claims cacher module 804. Claims cache 802 is used to cache claims received from claims provider 104 for identity principals, for subsequent access. Claims cacher module 804 is present to enable execution unit 102 to communicate with claims cache 802 for the storing and retrieving of claims.

Claims may be cached in claims cache 802 in any manner. For instance, FIG. 9 shows a step 902 for caching claims, according to an example embodiment. In step 902, the received one or more claims are stored in a claims cache. For instance, as described above, in step 210 of flowchart 200 (FIG. 2), one or more claims for an identity principal may be received by execution unit 302 from claims provider 104. In an embodiment, claims cacher module 804 may cache the received one or more claims in claims cache 802 according to a caching request 806. Caching request 806 indicates the identified identity principal and the one or more claims (e.g., one or more claim name and claim value pairs) received for the identified identity principal from claims provider 104. Claims cache 802 stores the received claims as claims 814 in association with the identified identity principal. Claims 814 may be stored in any form, including in the form of a data structure (e.g., a file, as entries in a table or array, etc.). Claims cache 802 may optionally transmit an indication to claims cacher module 804 of whether the caching of the claims was successful in caching results indication 808.

In embodiments, claims cache 802 may store any number of claims for any number of identity principals, which may be received from any number of execution units operating in computing device 800. Claims cache 802 may reside in any storage associated with computing device 800, such as storage (e.g., memory) described elsewhere herein for computing environment 100 (of FIG. 1).

Claims may be retrieved from claims cache 802 in any manner. For instance, FIG. 10 shows a flowchart 1000 providing a process for accessing a claims cache for claims, according to an example embodiment. Flowchart 1000 is described as follows with reference to FIG. 8. Further structural and operational embodiments will be apparent to persons skilled in the relevant art(s) based on the following discussion regarding flowchart 1000.

Flowchart 1000 begins with step 1002. In step 1002, a claims cache is attempted to be accessed for the one or more claims associated with the identified identity principal. For instance, during flowchart 200 (FIG. 2), before performing step 208 (requesting claims from the claims provider), claims cacher module 804 may attempt to access the claims of the identity principal from claims cache 802. As shown in FIG. 8, claims cacher module 804 may transmit a cached claims request 810 to claims cache 802. Cached claims request 810 may identify the identity principal identified in step 204 of flowchart 200, and may be a request for all claims, or one or more specific claims, cached in claims cache 802 for that identity principal. Claims cache 802 may provide one or more claims cached for the identified identity principal in cached claims response 812.

In step 1004, if the one or more claims associated with the identified identity principal are successfully accessed in the claim cache, the request for the one or more claims from a claims provider may be skipped. In an embodiment, if claims cacher module 804 receives the desired claim(s) for the identified identity principal in step 1002, steps 208 and 210 of flowchart 200 (retrieval of claims for the identity principal from claims provider 104) may be skipped. If claim(s) of interest for the identity principal is/are not received in step 1002, steps 208 and 210 of flowchart 200 may be performed to obtain the identity principal claims.

### III Example Computing Device Embodiments

Execution unit 102, claims provider 104, user identity manager 106, execution unit 302, user identification module 304, claims identifier module 306, user claims determiner 308, claims comparator 310, action determiner 312, policy engine 402, action performer 502, event generator 704, claims cache module 804, flowchart 200, flowchart 600, step 902, and flowchart 1000 may be implemented in hardware, software, firmware, or any combination thereof. For example, execution unit 102, claims provider 104, user identity manager 106, execution unit 302, user identification module 304, claims identifier module 306, user claims determiner 308, claims comparator 310, action determiner 312, policy engine 402, action performer 502, event generator 704, claims cache module 804, flowchart 200, flowchart 600, step 902, and/or flowchart 1000 may be implemented as computer program code configured to be executed in one or more processors. Alternatively, execution unit 102, claims provider 104, user identity manager 106, execution unit 302, user identification module 304, claims identifier module 306, user claims determiner 308, claims comparator 310, action determiner 312, policy engine 402, action performer 502, event generator 704, claims cache module 804, flowchart 200, flowchart 600, step 902, and/or flowchart 1000 may be implemented as hardware logic/electrical circuitry. For instance, in an embodiment, one or more of execution unit 102, claims provider 104, user identity manager 106, execution unit 302, user identification module 304, claims identifier module 306, user claims determiner 308, claims comparator 310, action determiner 312, policy engine 402, action performer 502, event generator 704, claims cache module 804, flowchart 200, flowchart 600, step 902, and/or flowchart 1000 may be implemented together in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

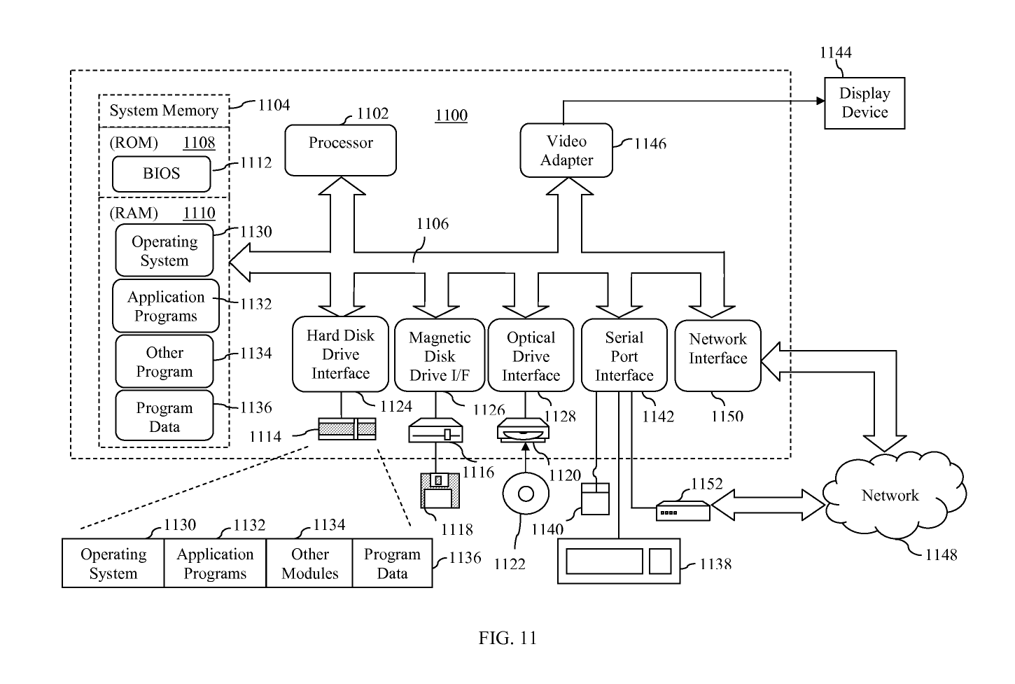

FIG. 11 depicts an exemplary implementation of a computer 1100 in which embodiments of the present invention may be implemented. For example, computing environment 100, computing device 400, computing device 700, and/or computing device 800 may be implemented in a computer system similar to computer 1100, including one or more features of computer 1100 and/or alternative features. Computer 1100 may be a general-purpose computing device in the form of a conventional personal computer, a mobile computer, a server, or a workstation, for example, or computer 1100 may be a special purpose computing device. The description of computer 1100 provided herein is provided for purposes of illustration, and is not intended to be limiting. Embodiments of the present invention may be implemented in further types of computer systems, as would be known to persons skilled in the relevant art(s).

As shown in FIG. 11, computer 1100 includes one or more processors 1102, a system memory 1104, and a bus 1106 that couples various system components including system memory 1104 to processor 1102. Bus 1106 represents one or more of any of several types of bus structures, including a memory bus or memory controller, a peripheral bus, an accelerated graphics port, and a processor or local bus using any of a variety of bus architectures. System memory 1104 includes read only memory (ROM) 1108 and random access memory (RAM) 1110. A basic input/output system 1112 (BIOS) is stored in ROM 1108.

Computer 1100 also has one or more of the following drives: a hard disk drive 1114 for reading from and writing to a hard disk, a magnetic disk drive 1116 for reading from or writing to a removable magnetic disk 1118, and an optical disk drive 1120 for reading from or writing to a removable optical disk 1122 such as a CD ROM, DVD ROM, or other optical media. Hard disk drive 1114, magnetic disk drive 1116, and optical disk drive 1120 are connected to bus 1106 by a hard disk drive interface 1124, a magnetic disk drive interface 1126, and an optical drive interface 1128, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1130, one or more application programs 1132, other program modules 1134, and program data 1136. Application programs 1132 or program modules 1134 may include, for example, computer program logic (e.g., computer program code or instructions) for implementing execution unit 102, claims provider 104, user identity manager 106, execution unit 302, user identification module 304, claims identifier module 306, user claims determiner 308, claims comparator 310, action determiner 312, policy engine 402, action performer 502, event generator 704, claims cache module 804, flowchart 200, flowchart 600, step 902, and/or flowchart 1000 (including any step of flowcharts 200, 600, and 1000), and/or further embodiments described herein.

A user may enter commands and information into the computer 1100 through input devices such as keyboard 1138 and pointing device 1140. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor 1102 through a serial port interface 1142 that is coupled to bus 1106, but may be connected by other interfaces, such as a parallel port, game port, or a universal serial bus (USB).

A display device 1144 is also connected to bus 1106 via an interface, such as a video adapter 1146. In addition to the monitor, computer 1100 may include other peripheral output devices (not shown) such as speakers and printers.

Computer 1100 is connected to a network 1148 (e.g., the Internet) through an adaptor or network interface 1150, a modem 1152, or other means for establishing communications over the network. Modem 1152, which may be internal or external, may be connected to bus 1106 via serial port interface 1142, as shown in FIG. 11, or may be connected to bus 1106 using another interface type, including a parallel interface.

As used herein, the terms “computer program medium,” “computer-readable medium,” and “computer-readable storage medium” are used to generally refer to media such as the hard disk associated with hard disk drive 1114, removable magnetic disk 1118, removable optical disk 1122, as well as other media such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1132 and other program modules 1134) may be stored on the hard disk, magnetic disk, optical disk, ROM, or RAM. Such computer programs may also be received via network interface 1150, serial port interface 1142, or any other interface type. Such computer programs, when executed or loaded by an application, enable computer 1100 to implement features of embodiments of the present invention discussed herein. Accordingly, such computer programs represent controllers of the computer 1100.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method, comprising:
executing an execution unit;
identifying an identity principal under which the execution unit is executed;
identifying at least one claim that is required for the execution unit, each identified claim having a claim name and a claim value;
requesting one or more claims associated with the identified identity principal from a claims provider;
receiving the one or more claims from the claims provider;
comparing the received one or more claims with the identified at least one claim; and
determining an action for the identified at least one claim based on a result of the comparison.

2. The method of claim 1, wherein said identifying at least one claim that is required for the execution unit comprises:
identifying a plurality of claims required for the execution unit;
said comparing the received one or more claims with the identified at least one claim comprises:
comparing the one or more claims with the identified plurality of claims; and
said determining an action for the identified at least one claim based on a result of the comparison comprises:
determining an action for the identified plurality of claims based on a result of the comparison.

3. The method of claim 1, wherein said determining comprises:
accessing a claims execution map for at least one entry corresponding to the identified at least one claim, each entry of the claims execution map including
an execution unit name,
a name of a claim corresponding to the entry,
an expected value for the claim corresponding to the entry,
a first action to be performed if the claim corresponding to the entry is satisfied, and
a default action to be performed if the claim corresponding to the entry is not satisfied.

4. The method of claim 1, wherein said determining comprises:
selecting a first action to be performed if the comparison result indicates that the identified at least one claim is satisfied; and
selecting a default action to be performed if the comparison result indicates that the identified at least one claim is not satisfied.

5. The method of claim 1, further comprising:
performing the determined action.

6. The method of claim 5, wherein said performing comprises:
performing at least one of
continuing to execute the execution unit,
skipping further execution of the execution unit,
throwing an exception,
logging an event in an event log, or
changing a behavior of the execution unit.

7. The method of claim 1, further comprising:
storing the received one or more claims in a claims cache, the one or more claims being accessible in the claims cache when a subsequent claim is processed instead of re-requesting the one or more claims from the claims provider.

8. The method of claim 1, further comprising:
prior to said requesting one or more claims associated with the identified identity principal from a claims provider,
attempting to access a claims cache for the one or more claims associated with the identified identity principal; and
skipping said requesting one or more claims associated with the identified identity principal from a claims provider if the one or more claims associated with the identified identity principal are successfully accessed in the claim cache.

9. An execution unit configured to be executed by a computing device, comprising:
a user identification module that identifies an identity principal under which the execution unit is executed;
a claims identifier module that identifies at least one claim that is required for the execution unit, each identified claim having a claim name and a claim value;
a user claims determiner that requests one or more claims associated with the identified identity principal from a claims provider, and receives the one or more claims from the claims provider;
a claims comparator that compares the received one or more claims with the identified at least one claim; and
an action determiner that determines an action for the identified at least one claim based on a result of the comparison.

10. The execution unit of claim 9, wherein the claims identifier identifies a plurality of claims required for the execution unit;
said claims comparator compares the received one or more claims with the identified plurality of claims; and
said action determiner determines an action for the identified plurality of claims based on a result of the comparison.

11. The execution unit of claim 9, wherein the action determiner accesses a claims execution map for at least one entry corresponding to the identified at least one claim, each entry of the claims execution map including
an execution unit name,
a name of a claim corresponding to the entry,
an expected value for the claim corresponding to the entry,
a first action to be performed if the claim corresponding to the entry is satisfied, and
a default action to be performed if the claim corresponding to the entry is not satisfied.

12. The execution unit of claim 9, wherein the action determiner selects a first action to be performed if the comparison result indicates that the identified at least one claim is satisfied, and selects a default action to be performed if the comparison result indicates that the identified at least one claim is not satisfied.

13. The execution unit of claim 9, further comprising:
an action performer configured to enable the determined action to be performed.

14. The execution unit of claim 9, wherein the determined action includes at least one of continuing to execute the execution unit, skipping further execution of the execution unit, throwing an exception, logging an event in an event log, or changing a behavior of the execution unit.

15. The execution unit of claim 9, further comprising:
a claims cacher module that stores the received one or more claims in a claims cache, the one or more claims being accessible in the claims cache when a subsequent claim is processed instead of the one or more claims being re-requested from the claims provider.

16. The execution unit of claim 9, wherein prior to requesting the one or more claims associated with the identified identity principal from a claims provider, the user claims determiner attempts to access a claims cache for the one or more claims associated with the identified identity principal; and
the user claims determiner skips requesting the one or more claims associated with the identified identity principal from the claims provider if the one or more claims associated with the identified identity principal are successfully accessed in the claim cache.

17. A computer readable storage medium having computer program instructions embodied in said computer readable storage medium for enabling a processor to execute an execution unit, the computer program instructions comprising:
first computer program instructions that enable the processor to identify an identity principal under which the execution unit is executed;
second computer program instructions that enable the processor to identify at least one claim that is required for the execution unit, each identified claim having a claim name and a claim value;
third computer program instructions that enable the processor to attempt to retrieve one or more claims associated with the identified identity principal from a claims cache;
fourth computer program instructions that enable the processor to retrieve one or more claims associated with the identified identity principal from a claims provider if the one or more claims associated with the identified identity principal are not successfully retrieved from the claim cache;
fifth computer program instructions that enable the processor to compare the retrieved one or more claims with the identified at least one claim; and
sixth computer program instructions that enable the processor to determine an action for the identified at least one claim based on a result of the comparison.

18. The computer readable storage medium of claim 17, wherein the second computer program instructions enable the processor to identify a plurality of claims required for the execution unit;
the fifth computer program instructions enable the processor to compare the one or more claims with the identified plurality of claims; and
the sixth computer program instructions enable the processor to determine an action for the identified plurality of claims based on a result of the comparison.

19. The computer readable storage medium of claim 17, wherein said sixth computer program instructions comprise:
seventh computer program instructions that enable the processor to access a claims execution map for at least one entry corresponding to the identified claim, each entry of the claims execution map including
an execution unit name,
a name of a claim corresponding to the entry,
an expected value for the claim corresponding to the entry,
a first action to be performed if the claim corresponding to the entry is satisfied, and
a default action to be performed if the claim corresponding to the entry is not satisfied.

20. The computer readable storage medium of claim 17, wherein said sixth computer program instructions comprise:
seventh computer program instructions that enable the processor to select a first action to be performed if the comparison result indicates that the identified at least one claim is satisfied; and
eighth computer program instructions that enable the processor to select a default action to be performed if the comparison result indicates that the identified at least one claim is not satisfied.
